(19) United States
(12) Patent Application Publication
(10) Pub. No.: US 2011/0173377 A1
(43) Pub. Date: Jul. 14, 2011

(54) Secure portable data storage device

(76) Inventor: Richard T. Bonica, Houston, TX (US)

(21) Appl. No.: 12/798,721

(22) Filed: Apr. 9, 2010

Related U.S. Application Data
(60) Provisional application No. 61/335,899, filed on Jan. 13, 2010.

(51) Int. Cl. G06F 12/00

(52) U.S. Cl. 711/103; 711/E12.001; 711/E12.008; 711/115

(57) ABSTRACT

A portable memory device for use with a host device includes an array of non-volatile memory and a memory controller for performing memory access operations. A processor issues an authorization challenge to a host device prior to enabling external access to the memory. Upon receipt of a valid authorization from the host device, access is enabled. In one embodiment, the processor preconditions at least one signal in the interface between the host device and the memory controller. The preconditioning results in a desynchronization of synchronized signals applied at the memory device interface, thereby interfering with proper operation of the memory device. Attempts to access the memory device prior to authorization lead to intentional corruption of data stored in the memory. In alternative embodiment, a secure, machine-readable digital storage device is implemented as a boot device for a host machine. When booted off of the secure device operating system, the host machine's access to secure files on the secure digital storage device is restricted. When the secure digital storage device is accessed by a host device not booted off of the secure device's operating system, the secured files on the secure digital storage device are inaccessible.

### RELATED APPLICATIONS

This application claims the priority of prior provisional patent application Ser. No. 61/335,899 filed on Jan. 13, 2010. This application also claims the priority of prior provisional application Ser. No. 61/340,054 filed on Mar. 13, 2010.

### FIELD OF THE INVENTION

The present invention relates generally to digital data storage devices, and more particularly to a secure, portable data storage device.

### BACKGROUND OF THE INVENTION

Data storage devices generally, and portable data storage devices in particular, have become by the present time practically ubiquitous, and are encountered frequently in people's daily activities, both at home and at work. As used herein, the terms “storage device” and “memory device” will be used more or less interchangeably to refer to devices adapted to store digital information of any and all types (e.g., data files, application files, image files, audio files, etc.).

Conventional compact disks (CDs) and digital versatile disks (DVDs) store information in the form of individual bit locations that are written to and read from by means of an electro-optical system including a laser.

Electronic portable memory devices, on the other hand, store digital information using semiconductor memory technologies (such as Flash memory) and are most often equipped with an interface of some sort to facilitate access to digital information stored on the device. As used herein, the term “interface” refers to both the logical protocol(s) and signal timing involved in performing memory operations, as well as to the configuration of electrical contacts (pinout) and physical/mechanical coupling between a memory device and a host.

Memory devices may be “read only,” meaning that it is only possible to read information stored in the device, or “read-write,” meaning that information can be written to and read from the device. Digital information (e.g., binary digits) is customarily stored and accessed in sequential locations in the memory device, with the information being organized into sectors of, for example, 512 bytes.

Portable electronic memory devices, including non-volatile memory cards, have been commercially implemented according to a number of well-known standards or protocols governing the means and methods by which information is stored on and retrieved from memory. Memory cards are used with personal computers, cellular telephones, personal digital assistants, digital cameras, portable audio players and an increasing variety of other host electronic devices for the storage of large amounts of data. Such cards usually contain a non-volatile semiconductor memory cell array along with a controller that controls operation of the memory cell array and interfaces with a host to which the card connected.

One such standard, the PC Card Standard, provides specifications for three types of PC Cards. Originally released in 1990, the PC Card Standard now contemplates three forms of a rectangular card measuring 85.6 mm. by 54.0 mm., having thicknesses of 3.3 mm. (Type I), 5.0 mm. (Type II) and 10.5 mm. (Type III). An electrical connector, which engages pins of a slot in which the card is removably inserted, is provided along a narrow edge of the card. PC Card slots are included in current notebook personal computers, as well as in other host equipment, particularly portable devices. The PC Card Standard is a product of the Personal Computer Memory Card International Association (PCMCIA). The latest release of the PC Card Standard from the PCMCIA is dated February 1995, which standard is incorporated herein by this reference.

In 1994, SanDisk Corporation introduced the CompactFlash™ card (CF™ card) that is functionally compatible with the PC Card but is much smaller. The CF™ card is rectangularly shaped with dimensions of 43 mm. by 36 mm. and a thickness of 3.3 mm., and has a female pin connector along one edge. The CF™ card is widely used with cameras for the storage of video data. A passive adapter card is available, in which the CF™ card fits, that then can be inserted into a PC Card slot of a host computer or other device. The controller within the CF™ card operates with the card's flash memory to provide an ATA interface at its connector. That is, a host with which a CF™ card is connected interfaces with the card as if it is a disk drive. Specifications for the card have been developed by the CompactFlash Association, a current version of these specifications being 1.4, which standard is incorporated herein by this reference.

The SmartMedia™ card is about one-third the size of a PC Card, having dimensions of 45.0 mm. by 37.0 mm. and is very thin at only 0.76 mm. thick. Contacts are provided in a defined pattern as areas on a surface of the card. Its specifications have been defined by the Solid State Floppy Disk Card (SSFDC) Forum, which began in 1996. It contains flash memory, particularly of the NAND type. The SmartMedia™ card is intended for use with portable electronic devices, particularly cameras and audio devices, for storing large amounts of data. A memory controller is included either in the host device or in an adapter card in another format such as one according to the PC Card standard. Physical and electrical specifications for the SmartMedia™ card have been issued by the SSFDC Forum, a current version of this standard being 1.0, which standard is incorporated herein by this reference.

Another non-volatile memory card is the MultiMediaCard (MMC™). The physical and electrical specifications for the MMC are given in “The MultiMediaCard System Specification” that is updated and published from time-to-time by the MultiMediaCard Association (MMCA). Version 3.1 of that Specification, dated June 2001, is expressly incorporated herein by this reference. MMC™ products having varying storage capacity up to 128 megabytes in a single card are currently available from SanDisk Corporation. The MMC™ card is rectangularly shaped with a size similar to that of a postage stamp. The card's dimensions are 32.0 mm. by 24.0 mm. and 1.4 mm. thick, with a row of electrical contacts on a surface of the card along a narrow edge that also contains a cut-off corner. These products are described in a “MultiMediaCard Product Manual,” Revision 2, dated April 2000, published by SanDisk Corporation, which Manual is expressly incorporated herein by this reference. Certain aspects of the electrical operation of the MMC products are also described in U.S. Pat. No. 6,279,114 and in patent application Ser. No. 09/186,064, filed Nov. 4, 1998, both by applicants Thomas N. Toombs and Micky Holtzman, and assigned to SanDisk Corporation. The physical card structure and a method of manufacturing it are described in U.S. Pat. No. 6,040,622, assigned to SanDisk Corporation. This patent and patent application are expressly incorporated herein by this reference.

A modified version of the MMC™ card is the later Secure Digital (SD) card, according to a standard promoted by Matsushita, SanDisk and Toshiba Corporation, which were jointly responsible for creation of the SD Card Association, headquartered in California and having executive membership including some 30 world-leading high-tech companies and major content companies.

The SD Card has the same rectangular size as the MMC card but with an increased thickness (2.1 mm.) in order to accommodate an additional memory chip when that is desired. A primary difference between these two cards is the inclusion in the SD card of security features for its use to store and copy protect proprietary data such as music files or other copyrighted works. Another difference between them is that the SD Card includes additional data contacts in order to enable faster data transfer between the card and a host. The other contacts of the SD Card are the same as those of the MMC™ card in order that sockets designed to accept the SD Card can also be made to accept the MMC™ card. This is described in PCT published application no. WO 02/15020 of Yoram Cedar, Micky Holtzman and Yosi Pinto, published Feb. 21, 2002, which publication is incorporated herein by this reference. The electrical interface with the SD card is further made to be, for the most part, backward compatible with the MMC™ card, in order that few changes to the operation of the host need be made in order to accommodate both types of cards. In each, a memory controller includes a microprocessor that manages operation of the memory and performs some limited operations on data being written to or read from the memory. Specifications for the SD card are available to member companies from the SD Association (SDA).

Another type of memory card is the Subscriber Identity Module (SIM), the specifications of which are published by the European Telecommunications Standards Institute (ETSI). A portion of these specifications appear as GSM 11.11, a recent version being technical specification ETSI TS 100 977 V8.3.0 (2000 08), entitled “Digital Cellular Telecommunications System (Phase 2+); Specification of the Subscriber Identity Module-Mobile Equipment (SIM-ME) Interface,” (GSM 11.11 Version 8.3.0 Release 1999). This specification is hereby incorporated herein by this reference. Two types of SIM cards are specified: an ID-1 SIM and a Plug-in SIM. In practice, a primary component of each SIM card is a SIM integrated circuit chip.

The ID-1 SIM card has a format and layout according to the ISO/IEC 7810 and 7816 standards of the International Organization for Standardization (ISO) and the International Electrotechnical Commission (IEC). The ISO/IEC 7810 standard is entitled “Identification cards—Physical characteristics,” second edition, August 1995. The ISO/IEC 7816 standard has the general title of “Identification cards-Integrated Circuit(s) Cards with Contacts,” and consists of parts 1 10 that carry individual dates from 1994 through 2000. These standards, copies of which are available from the ISO/IEC in Geneva, Switzerland, are expressly incorporated herein by this reference. The ID-1 SIM card is generally the size of a credit card, having dimensions of 85.60 mm. by 53.98 mm., with rounder corners, and a thickness of 0.76 mm. Such a card may have only memory or may also include a microprocessor, the latter often being referred to as a “Smart Card.” One application of a Smart Card is as a debit card where an initial credit balance is decreased every time it is used to purchase a product or a service.

The Plug-in SIM is a very small card, smaller than the MMC™ and SD cards. The GSM 11.11 specification referenced above calls for this card to be a rectangle 25 mm. by 15 mm., with one corner cut off for orientation, and with the same thickness as the ID-1 SIM card. A primary use of the Plug-in SIM card is in mobile telephones and other portable devices. In both types of cards including the SIM, eight electrical contacts (but with as few as five being used) are specified in the ISO/IEC 7816 standard to be arranged on a surface of the card for contact by a host receptacle.

One function of the SIM provides a level of security for the device in which it is used. In a mobile communications device such as a cellular telephone, the device is authenticated by the communications network sending a random number to the device that is processed by a given algorithm, and the result is sent back to the network. The network compares that result with one it calculates itself by use of the same algorithm. If the results match, communication by the device over the network is enabled. A subscriber authentication key is stored in the SIM for use in this and other security algorithms. The SIM can also operate to control and support various operations of the device in which it is removably installed.

For applications utilizing both a non-volatile memory card and a SIM card, the SIM integrated circuit chip is conveniently incorporated within the memory card. This is described in PCT published application no. WO 02/13021 of Robert Wallace, Wesley Brewer and Yosi Pinto, published Feb. 14, 2002, which publication is incorporated herein by this reference. A SIM chip within either a MMC or a SD card shares the memory card's external contacts for access by a host system with which the memory card is connected.

Sony Corporation has commercialized a non-volatile memory card, sold as the Memory Stick™, that has yet another set of specifications. Its shape is that of an elongated rectangle having electrical contacts on a surface adjacent one of its short sides. The electrical interface through these contacts with a host to which it is connected is unique. No microprocessor or other processing unit is included in the card but rather the host with which it is removably inserted provides the necessary intelligence.

As is apparent from the foregoing summary of electronic card standards, there are many differences in their physical characteristics including size and shape, in the number, arrangement and structure of electrical contacts and in the electrical interface with a host system through those contacts when the card is inserted into the host card slot. Differences also exist in the amount of control and data processing that occur within the cards. Adaptors, both active and passive types, allow some degree of interchangeability of electronic cards among such host devices. U.S. Pat. No. 6,266,724 of Harari et al. describes uses of combinations of mother and daughter memory cards, which patent is incorporated herein in its entirety by this reference.

Although the access protocols, electrical pin configurations, and storage organization may vary from one brand of portable memory device to another (often according to proprietary or industry-standard definitions), accessing the data (reading and/or writing) in most types of these devices involves a “host” device specifying an access operation to be performed (e.g., READ or WRITE) along with address(es) of the location(s) to be accessed (read from or written to). The interface usually includes one or more data connections on which READ data and WRITE data appear depending on the operation type. As used herein, the term “host device” is intended to refer to any device that is adapted to access the digital information stored on a portable storage device. Host devices include all types of computers, cell phones, cameras, printers, PDAs, and countless other electronic devices which process, display, manipulate, or otherwise make use of digital information.

Many portable memory devices are synchronous in operation, meaning that a digital clocking signal is applied to the device during access operations, and the operations are performed in timed synchronization to this clocking signal. Often, the digital clocking signal is provided externally by the host device that is accessing the stored digital information.

Portable memory devices are frequently used to store digital information that is sensitive for some reason or another and is therefore preferably secured to some extent. For example, the stored digital information may be a copyrighted work whose distribution, duplication, and use is restricted by operation of applicable copyright laws. The stored digital information may comprise confidential information, such as a person's medical records. Numerous other examples of such sensitive digital information will be apparent to persons of ordinary skill in the art. Consequently, it would be considered desirable to have some means of securing the information stored on a portable memory device such that access to the stored information is restricted.

### SUMMARY OF THE INVENTION

In view of the foregoing and other considerations, the present invention is directed to a portable memory device for storing digital information to be accessed by a host device. In accordance with one aspect of the invention, the memory device includes control circuitry for implementing an access control function for stored information. In one embodiment of the invention, the memory device issues an authentication challenge to a host device prior to permitting any access to information stored on the memory.

In accordance with another aspect of the invention, the access control circuitry is operative to de-synchronize at least one externally applied signal on the device interface prior to issuance of the authentication challenge. If the authentication challenge is met by the host device, de-synchronization of externally applied signals is discontinued and access to the stored information is permitted.

In accordance with another aspects of the invention, if a memory device's authorization challenge is not met by the host device, the de-synchronization of applied signal(s) continues, and as a consequence, further attempts to access the device will be unsuccessful and can result in permanent, intentional corruption of information stored on the device.

### BRIEF DESCRIPTION OF THE DRAWINGS

The present invention is best understood with reference to the following detailed description of embodiments of the invention when read in conjunction with the attached drawings, in which like numerals refer to like elements, and in which:

FIG. 1 is a functional block diagram of a prior art portable memory device;

FIG. 2 is a functional block diagram of a portable memory device in accordance with one embodiment of the invention;

FIG. 3 is a timing diagram illustrating the de-synchronization of an external clock signal applied to the memory device of FIG. 2; and

FIG. 4 is a functional block diagram of a system including a secure digital storage device in accordance with an alternative embodiment of the invention.

### DETAILED DESCRIPTION OF A PREFERRED EMBODIMENT OF THE INVENTION

In the disclosure that follows, in the interest of clarity, not all features of actual implementations are described. It will of course be appreciated that in the development of any such actual implementation, as in any such project, numerous engineering and technical decisions must be made to achieve the developers' specific goals and subgoals (e.g., compliance with system and technical constraints), which will vary from one implementation to another. Moreover, attention will necessarily be paid to proper engineering practices for the environment in question. It will be appreciated that such development efforts might be complex and time-consuming, outside the knowledge base of typical laymen, but would nevertheless be a routine undertaking for those of ordinary skill in the relevant fields.

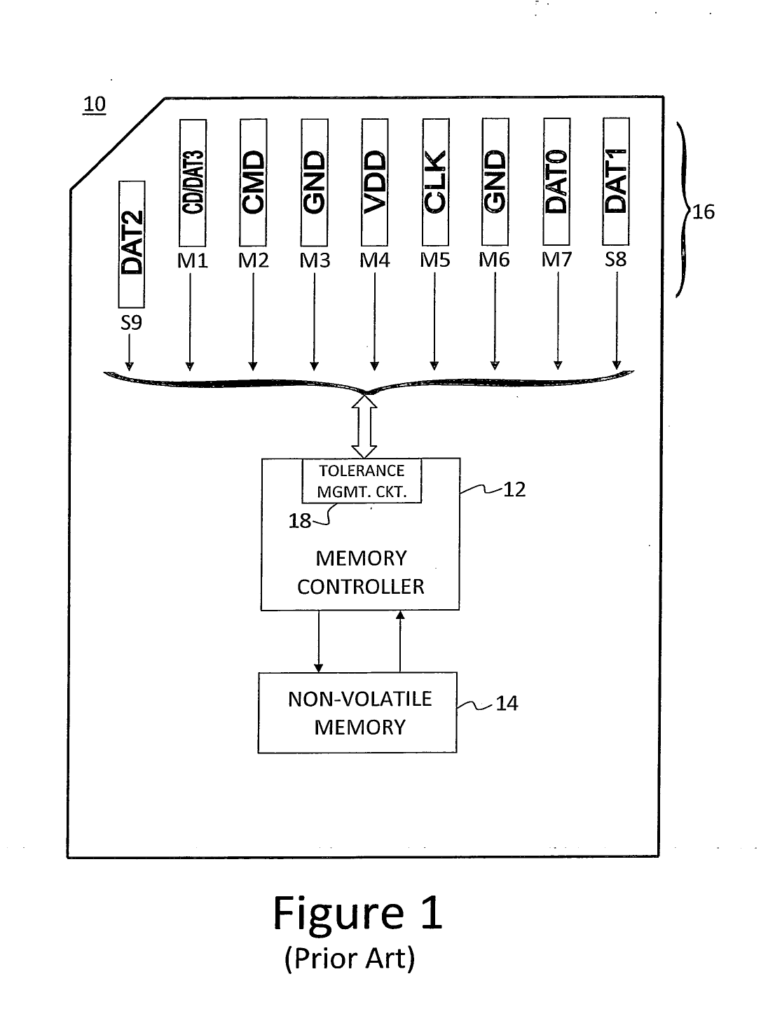

Referring to FIG. 1, there is shown a functional block diagram of a portable memory device 10 in accordance with conventional designs. As shown in FIG. 1, device 10 includes a quantity of non-volatile memory 12, such as Flash memory, and a memory controller 14. The memory controller 14 is coupled to an interface 16 comprising a plurality of electrical contacts designated M1-M7, S8, and 59. In the example of FIG. 1, memory device 10 conforms to the well-known SD standard for portable memory devices, which defines the function of each external contact, as follows:

| Contact | Function |
|---|---|
| M1 | Data3 |
| M2 | Command (CMD) |
| M3 | Ground (GND) |
| M4 | Vdd (voltage supply) |
| M5 | Clock (CLK) |
| M6 | Ground (GND) |
| M7 | Data0 |
| S8 | Data1 |
| S9 | Data2 |

Device 10 is synchronous in operation, with memory functions (reads and writes) being carried out in synchronization with an external digital clock signal applied on the CLK input M5 of interface 16. In one embodiment, the clock signal is a 16 MHz signal. In operation, a memory operation is initiated by serially applying an operation code (for example, 4 bits) on the CMD terminal M2 of interface 16. The memory controller decodes the command operation code to determine what memory operation is to be performed. After decoding, a memory address must be specified. The address is applied to one or more of the DATA connections M7, S8, S9, and M1, and specifies a particular location in memory array 12.

Depending upon whether a READ or WRITE operation is specified, data is either applied to the DATA connections M7, S8, S9, and M1 for writing into the array 12 (a WRITE operation) or data stored at the specified location is presented on the data connections for reading by the host device (not shown) coupled to the electrical contacts (a READ operation). As would be appreciated by those of ordinary skill in the art, the number of bits that can be written or read in a given operation cycle is limited to the number of data pins specified for the memory device interface 16. In the illustrative embodiment of FIG. 1 (and in accordance with the SD standard), there are four data lines DAT0, DAT1, DAT2 and CD/DAT3 that are part of interface 16. As would also be appreciated by those of ordinary skill, an address specified for a READ or WRITE operation can constitute the starting address for a sequence of successive operations, in order that a READ or WRITE operation can involve more than four bits of data (for example, 64 bits of data written or read in 16 successive writes or reads of four bits each, beginning at the specified address in memory). Of course, during such a succession of reads or writes, the data must be applied to the memory device interface (the data pins) in synchronization with the CLK signal. Those of ordinary skill in the art will understand that oftentimes synchronization with a clock signal involves detection of rising edges (low-to-high) or falling edges (high-to-low) of the clock signal.

With continued reference to FIG. 1, and in accordance with conventional practices, associated with memory controller 12 in memory device 10 is a voltage tolerance management circuit 18 which is directly coupled to interface 16. Among other functions, tolerance management circuit 18 operates to protect the memory controller 12 and memory array 14 from overvoltages and other conditions that could lead to physical damage to the internal logic of memory device 10.

In accordance with conventional design, memory 10 is operable with a logic voltage which ranges from 0V (a logical “0”) and 3.3V (a logical “1”). Thus, for example, the clock signal CLK appearing on terminal M5 of interface 16 is an oscillating square wave which ranges between 0V and 3.3V. One effect of tolerance management circuitry 18 is that voltages exceeding 3.3V appearing on any particular terminal of interface 16 are electrically blocked from reception at any internal functional block of memory controller 12. This avoids unintentional damage to the device due to overvoltages appearing on the device interface. Thus, as a result of inclusion of tolerance management circuit 18, for any input signal intended to range between 0V (logical “0”) and 3.3V (logical “1”), any applied voltage substantially exceeding 3.3V is effectively blocked, meaning that it will be interpreted by memory controller 12 as signaling a logical “0”. The inclusion and operation of protection circuitry like tolerance management circuit 18 is commonplace in the art.

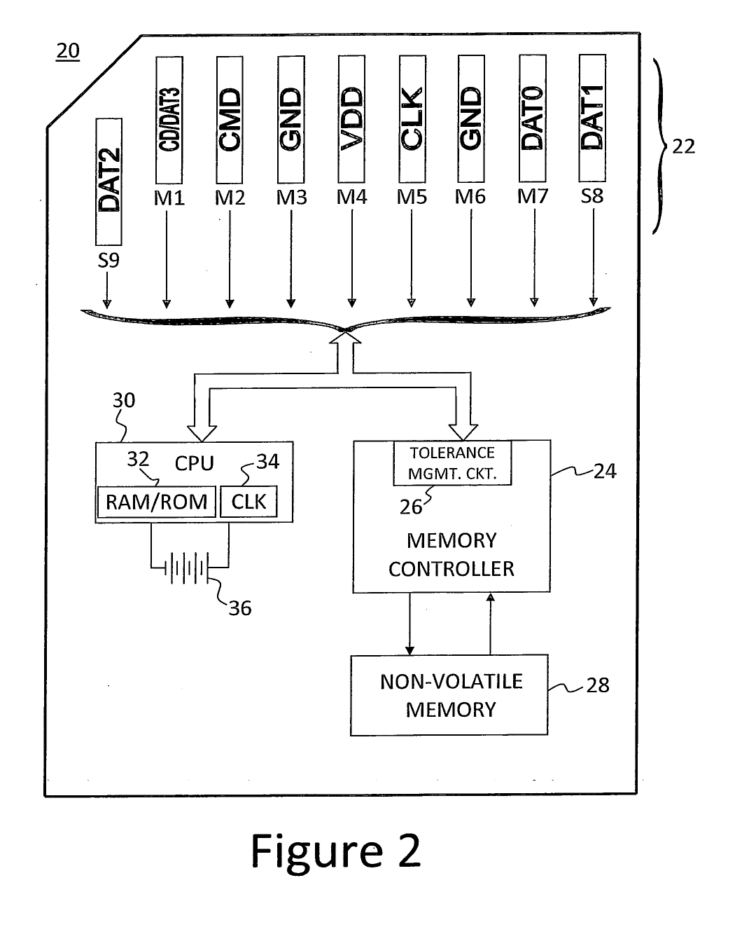

Turning now to FIG. 2, there is shown a functional block diagram of a portable memory device 20 in accordance with an exemplary embodiment of the invention. As shown in FIG. 2, device 20 includes an interface 22 including a plurality of individual electrical contacts M1-M7, S8, S9 whose definitions are essentially identical to those described above with reference to FIG. 1. Device 20 further includes a memory controller 24 including voltage tolerance management circuitry 26, again being substantially to those described herein with reference to FIG. 1. Further, device 20 includes a memory array 28, which may be, for example, conventional Flash memory.

With continued reference to FIG. 2, device 20 further includes a processor subsystem 30 which preferably includes local RAM/ROM/EEPROM storage 32 and a clock generator 34 for generating an internal clock signal. Optionally, processor 30 may have its own power supply (battery) 36.

In one embodiment, processor subsystem 30 is a BASIC Stamp 1 Microcontroller Module, commercially available from Parallax, Inc., Rocklin, Calif.; however, those of ordinary skill in the art having the benefit of the present disclosure will recognize that other microcontrollers and controller circuits may also be suitable for the purposes of practicing the present invention.

As shown in FIG. 2, processor 30 is coupled directly to interface 22, such that any signals appearing on the terminals of interface 22 are routed directly to both processor 30 and to controller 24 (via tolerance management circuit 26). As a result of this arrangement, it is possible for processor 30 to drive signals on the connectors of interface 22, and such signals would be seen both at interface 22 and at the input to memory controller 24.

The memory 32 of processor 30 includes program instructions for operating processor 30 in the manner described herein, and it is believed that it would be a matter of routine engineering for those of ordinary skill in the art to program processor 30 to operate as described herein.

As would be familiar to persons of ordinary skill in the art, processor 30 is preferably responsive to activation of device 20, such as by insertion of device 20 into a host device, to initiate a startup sequence prior to any data in array 28 from being accessed. This functionality is similar to the “autorun” feature that is often invoked when peripheral devices like memory cards and the like are connected to Windows®-based computer systems.

In the presently disclosed embodiment, part of the initiation sequence performed by processor 30 involves issuing an authorization challenge to the host device. This challenge is issued through the processor 30 asserting appropriate command and data signals on interface 22 to communicate with the host device. The authorization challenge can take many different forms. As a simple example, processor 30 may request the host device provide a predetermined authorization code (e.g., password) to processor 30. The authentication challenge can involve one password, multiple passwords, and so on. The processor 30 may give the host device more than one chance to provide the correct authorization code.

In response to the authorization challenge, the host device (not shown in FIG. 2) responds by asserting the appropriate command, address, and data signals on interface 22 to communicate the requested information to processor 30. The correct authorization code(s) are preferably stored in the processor's memory 30 and as such are inaccessible to the host device (unless processor 30 is purposefully programmed otherwise, which may or may not be desirable from implementation to implementation).

Preferably, until such time as the authorization challenge is met by a host device, processor 30 functions to perform a preconditioning of at least one signal on interface 22, with the intention of this preconditioning making it impossible to operate memory device 20 in order to access information stored in memory array 28.

In particular, in one embodiment of the invention, processor 30 is programmed to assert a logical output signal (in one case, a single logical value) referred to herein as an AUTH (for “authorization”) signal whose logic value (“0” or “1”) reflects whether device 20 is in an authorized condition under which the host device is able to access non-volatile memory 28 via interface 22 and memory controller 24.

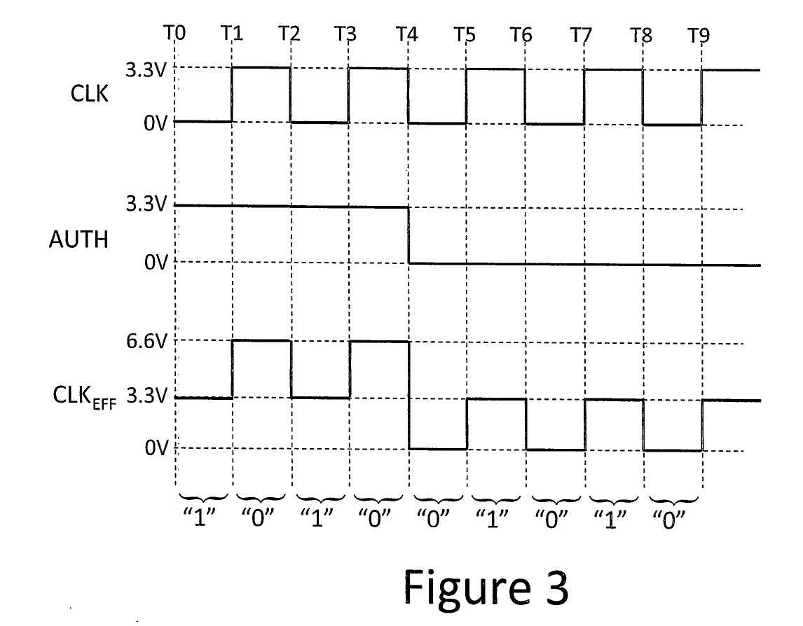

Referring also to FIG. 3, in an exemplary embodiment, processor 30 drives a logical “high” or “1” signal on an output coupled to the M5 terminal of interface 22, which is designated to carry an external clock signal CLK from the host device coupled to interface 22. In this embodiment, and as shown in FIG. 3, the logical “high” or “1” AUTH signal driven by processor 30 on the M5 (CLK) terminal is represented by a positive voltage, for example 3.3V.

The CLK signal normally driven the host device on the M5 terminal of interface 22 is also shown in FIG. 3 as an oscillating 3.3V square wave. Those of ordinary skill in the art will recognize that in instances when processor 30 is asserting the AUTH signal, the effect will be additive on the CLK signal driven by the host device on terminal M5 of interface 22. Consequently, the voltage appearing on the M5 input as “seen” by controller 24 will be substantially in excess of 3.3V, in some cases even approaching 2×3.3=6.6V. Herein, this effective clock signal is designated CLK_{EFF}, and is shown in the timing diagram of FIG. 3.

As shown in FIG. 3, time T0 represents a period of time during the initialization sequence for device 20, during which time processor 30 issues an authorization challenge to a host device and during which time processor 30 preferably maintains the AUTH output at a logical high level (3.3V), as shown in FIG. 3. As noted above, the CLK signal in FIG. 3 represents the signal driven on terminal M5 of interface 22 by the host device.

From time T0 to T1, CLK is low (0V) and AUTH is high (3.3V), leaving an effective clock signal CLK_{EFF} of approximately 3.3V. At time T1, CLK goes high, raising the effective clock signal CLK_{EFF} to a voltage approaching 6.6V for the interval from T1 to T2.

At time T2, CLK goes low again, and so on, until time T4, at which time processor 30 deasserts the AUTH signal (0V). At the same time, T4, the CLK signal goes low, resulting in an effective clock signal CLK_{EFF}=0V. The de-assertion of the AUTH signal may occur, for example, when processor 30 determines that the host device has successfully responded to the authorization challenge with the correct password, for example. AUTH preferably remains deasserted (low) for as long as operation of device 20 is to be authorized. With AUTH deasserted, beginning at time T4 the CLK_{EFF} will exactly follow the CLK signal.

As can be observed from FIG. 3, the preconditioning of the CLK terminal M5 causes the CLK_{EFF} signal to range from 0V to 3.3V to 6.6V. As described above, the tolerance management circuitry associated with memory controller operates to avoid overvoltages which substantially exceed 3.3V. So, considering for example the time interval from T1 to T2, even though the CLK signal is high, the preconditioning of the CLK terminal causes CLK_{EFF} to be even higher, such that internally to memory controller, the clocking signal becomes a logical low signal (“0”). That is, the clock signal internal to memory controller 30 is desynchronized from the externally-applied clocking signal and hence from other associated command, address, and data signals applied to device 20. Thus, while AUTH is asserted to precondition the CLK terminal M5 of interface 22, the normal application of command, address, data, and clocking signals to device 20 will not result in proper operation of device 20.

In fact, it has been shown that as a result of the desynchronization of the clock signal internally to memory controller 24, one or more repeated unauthorized attempts to access memory array 28 (i.e., attempts to operate device 20 while AUTH is asserted) can actually lead to corruption of information stored in array 28. This can result, for example, if, due to the desynchronization of the internal clocking signal, a READ command is incorrectly decoded by memory controller as a WRITE command. Further address information applied to the device 20 will be incorrectly decoded so long as the internal clocking signal in memory controller 24 is desynchronized.

In the event that a host device fails to respond to an authorization challenge with the correct authorization codes or other responses, any of several results can ensue. First, processor 30 can simply continue to assert the AUTH preconditioning signal, thereby effectively disabling memory controller 24 from properly decoding addresses, commands, and data. As noted above, with every repeated attempt at unauthorized access to device 20, there is increased likelihood, at some point being nearly a certainty, that information stored in array 28 will be corrupted, even further ensuring that unauthorized access to the stored information will not occur.

Alternatively, or in addition, processor 30 can respond to authorization failures to purposely erase or over-write some or all information stored in memory array 28. This is possible since processor 30 shares the same interface 22 to the memory controller that a host device has. For very highly sensitive information stored in array 28, this would essentially guarantee that access to memory 28 is not granted to an unauthorized user/host device.

Those of ordinary skill will appreciate that in its initialization/startup sequence, processor 30 can, by virtue of its connection to the host device via interface 22, issue certain commands to the host device in addition to the authorization challenge described hereinabove.

In one embodiment, it is contemplated that memory array 28 can be used to store an operating system, and perhaps applications and data. In such an embodiment, processor 30 can issue commands to the host device which cause the host device to utilize portable memory 28 in place of, or in addition to, whatever memory resources may be native to the host device.

In one exemplary embodiment, the host device may be a conventional personal computer, and device 20 is activated by an activation event, such as by inserting the card into a suitable slot in the host device. Upon of the activation event, processor 30, under control of program instructions stored in the processors' memory 32, can issue commands which cause the host device to boot from and utilize portable memory 28 instead of the host device's own on-board memory or disk drive. The host device processor would then initiate an operating system environment based on the operating system stored in memory 28, and even execute applications stored in memory 28, rather than applications stored on the host device's disk drive. In this way, device 20 can essentially take over control of the host device.

In this embodiment, there is even further opportunity to ensure the security of sensitive information stored in memory 28. The operating system stored in memory 28 can be specifically implemented to render any part of memory 28 inaccessible to the host device. In the case of copyrighted information stored in memory 28, the operating system stored in memory 28 can be configured to ensure that no copying of the stored copyrighted information is copied from memory 28. The copyrighted material could still made available for viewing on the host device hardware, but the underlying content would be copy-protected, as would be apparent to those of ordinary skill having the benefit of this disclosure.

In still another embodiment of the invention, device 20 is utilized to store digital information for a specified length of time, after which the programming of processor 30 causes the information to be automatically erased from memory 28. Throughout the authorization period, sensitive or copyrighted information in memory 28 can be protected from copying by the host computer processor, which while coupled to device 20 can remain under complete control of processor 30 and the operating system and other program stored in memory 28. This requires only that processor 30 command the host processor to utilize memory 28 in place of the host device's native resources (memory, disk drive, etc.). Assuming proper programming, by a person of ordinary skill in the art having the benefit of the present disclosure, digital information stored in memory 28 can be completely secured to any imaginable extent. This includes complete erasure/destruction of data in memory 28 automatically, upon the occurrence of various events, such as unauthorized attempts to access device 20.

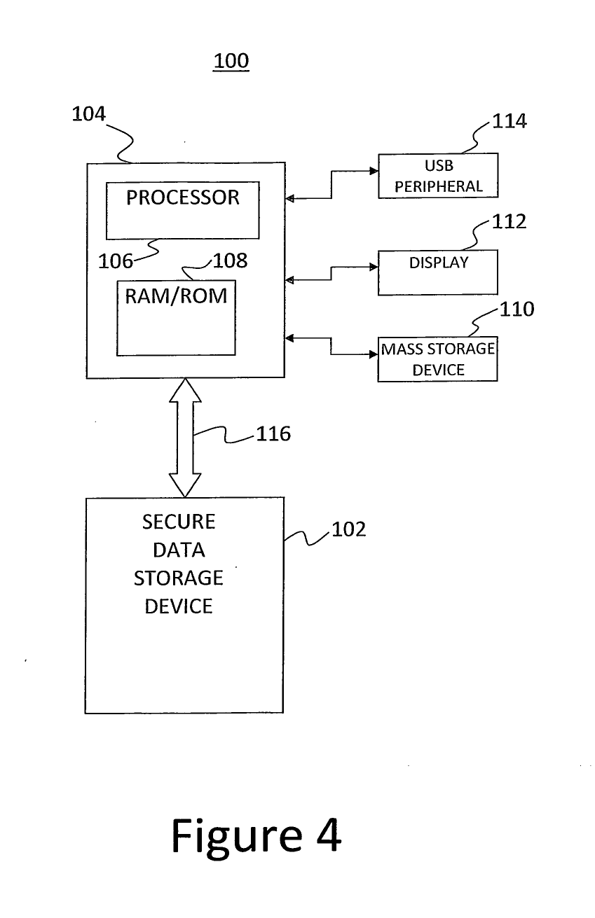

Turning to FIG. 4, there is shown a system 100 incorporating a secure data storage device 102 in accordance with an alternative embodiment of the invention. System 104 includes a host device 104, which as in the previously described embodiment may be any one of a number of different types of digital devices, including, without limitation, televisions and television monitors, computers, laptop computers, “netbooks,” cameras, telephones, tablet-type computing devices (such as the iPad™ device soon to be available from Apple Computer, Inc., Cupertino, Calif.

As is customary, host device 104 preferably has some degree of processing capability, as represented by processor block 106 in FIG. 4. Further, host device 104 preferably includes some quantity of native memory (RAM, ROM, or the like). Host device 104 further has interfaces to a plurality of peripheral devices, including, by way of example only, a mass storage device 110 such as a hard drive or the like, a display 112, USB peripherals, and the like, as would be familiar to those of ordinary skill in the art.

In one embodiment of the invention, during normal operation, the functionality of host device 104 is achieved by processor 106 executing program instructions stored in memory 108 or elsewhere. As would be familiar to those of ordinary skill in the art, a processor-based system will commence operation or “boot” by executing operating system program code, which governs all aspects of such a system's operation, including, without limitation, a host device's ability to communicate with or control various peripheral devices. This is known to those of ordinary skill in the art as the basic input/output system or BIOS component of a processor-based system such as a computer or the like. The operating system and BIOS for system 100 may be stored partially in the ROM portion of memory 108, and partially in the RAM portion of memory 108. The contents of RAM memory 108 in turn may be loaded from an external source, such as from mass storage device 110. For example, mass storage device 110 may be a magnetic hard drive storing operating system programming that is executed upon boot-up of system 100.

As would be familiar to those of ordinary skill in the art, it is possible for other peripheral devices to serve as “boot” devices of a processor based system.

With continued reference to FIG. 4, host device 104 is preferably in communication with a secure data storage device 102 in accordance with the presently disclosed embodiment of the invention, via a device interface 116. In accordance with one embodiment of the invention, secure data storage device 102 may be a conventional CD or DVD, and interface 116 comprises a CD or DVD drive capable of reading and/or writing to device 102 in a conventional manner.

In the disclosed embodiment of FIG. 4, secure device 102 is bootable, such that a custom operating system stored on device 102 (the “secure device operating system”) can take control of host device 104 and its BIOS functions. As such, the secure device's operating system can restrict the ability of host device 104 to communicate and operate with any of its peripherals, and even how processor 106 accesses memory 108.

Once system 100 is operating with the operating system on secure device 102 in control, it is possible for other data stored in device 102 to be handled in a secure fashion. For example, the secure device operating system can restrict system operation such that a secure data file on device 102 cannot be copied to memory 108, nor copied to mass storage device 110, nor to any USB peripheral. On the other hand, the operating system may allow for the secured data on device 102 to be provided directly to video processing circuitry for presentation on display 112.

The secure device operating system is further preferably in control of the memory and formatting of any data stored on secure device 102. As such, the secure device operating system can encrypt, encode, or otherwise obscure data files stored on device 102 such that these files are inaccessible to any host processor that is not operating under control of the secure device operating system. If secure device 102 is a CD or DVD disc, for example, the data files stored thereon could not be read or otherwise accessed using the CD/DVD reader of a conventional host computer; only a host device operating under control of the secure device operating system can access the secured data files on device 102.

From the foregoing description and disclosure of various embodiments of the invention, it will be apparent to those of ordinary skill in the relevant arts that a secure, portable memory device has been disclosed. Devices in accordance with the various embodiments of the invention and combinations thereof include novel features relating in particular to the ability to secure data stored in a portable storage device from unauthorized access and use. In other respects, the invention contemplates the ability of a portable memory device to interact with a host device in a manner in which the security and integrity of the information stored on the memory device is maintained.

Various embodiments of the invention are described herein solely for the purposes of illustrating the invention in its various aspects. It is contemplated and to be explicitly understood that various substitutions, alterations, and/or modifications, including but not limited to any such implementation variants and options as may have been specifically noted or suggested herein, including inclusion of technological enhancements to any particular method step or system component discovered or developed subsequent to the date of this disclosure, may be made to the disclosed embodiments of the invention without necessarily departing from the technical and legal scope of the invention as defined in the following claims.

What is claimed is:

1. A data storage device, comprising:
a quantity of memory for storing digital information, said digital information including operating system programming for controlling operation of a host device and said digital information further including data to be secured, said quantity of memory being readable by said host device;
wherein said operating system programming, when executed by said host device, restricts the manner in which said host device accesses said data to be secured.

2. A data storage device in accordance with claim 1, wherein said data to be secured is not readable by a host machine unless said host machine is executing said operating system programming.

3. A data storage device in accordance with claim 1, wherein said operating system programming, when executed by said host device, prevents said host device from copying said data to be secured.

4. A data storage device in accordance with claim 1, comprising a CD or DVD.

5. A data storage device in accordance with claim 4, wherein said data to be secured comprises an audiovisual file.

6. A method of securing information stored on a portable data storage device, comprising:
storing a secure operating system on said portable storage device, said secure operating system being executable by the processor of a host device;
storing at least one secure data file on said portable storage device, said secure data file being encoded in such a manner as to render it inaccessible to said host device unless said host device is operating under control of said secure operating system.
